(19) United States
(12) Patent Application Publication
(10) Pub. No.: US 2018/0169562 A1
(43) Pub. Date: Jun. 21, 2018

(54) CAPTURE AND REMOVAL OF TARGETED GAS

(71) Applicant: KONINKLIJKE PHILIPS N.V., EINDHOVEN (NL)

(72) Inventors: RAINER HILBIG, EINDHOVEN (NL); ACHIM GERHARD ROLF KOERBER, EINDHOVEN (NL); STEFAN WILLI JULIUS GRUHLKE, EINDHOVEN (NL); SHELLY SU, EINDHOVEN (NL)

(21) Appl. No.: 15/579,702

(22) PCT Filed: Jun. 24, 2016
(86) PCT No.: PCT/EP2016/064639

§ 371 Date: Dec. 5, 2017

(30) Foreign Application Priority Data
Jun. 24, 2015 (CN) PCT/CN2015/082191
Jul. 31, 2015 (EP) 15179280.1

(51) Int. Cl. B01D 53/04; B01J 20/16; B01J 20/34; F24F 11/30

(52) U.S. Cl. CPC B01D 53/0407; B01D 53/0454; B01J 20/165; B01J 20/3475; B01J 20/3408; F24F 2110/50; B01D 2253/108; B01D 2257/504; B01D 2259/401; B01D 2259/4508; B01D 2259/40083; F24F 11/30

(57) ABSTRACT

Apparatus and methods are disclosed herein for capturing targeted gas in air. An air purification apparatus (110) is presented comprising: a targeted gas capture chamber (120) with an air inlet (118) and an air-permeable wall (122) configured to at least partially capture a targeted gas from air that passes into the air inlet and through the air-permeable wall; and a targeted gas removal unit (126) that is periodically positionable adjacent to the air-permeable wall of the targeted gas capture chamber to at least partially remove, e.g., via adsorption, the targeted gas captured by the air-permeable wall. Further, an air purification apparatus is presented that comprises: a targeted gas capture chamber (120) with an air inlet (118) and an air-permeable wall (122) configured to at least partially capture a targeted gas from air that passes into the air inlet and through the air-permeable wall; a valve (116, 516) that is operable to permit air to flow into the targeted gas capture chamber (120, 520); and a controller (114) operably coupled with the valve and configured to make a determination, based on a signal indicative of a level of the targeted gas detected in the air, that a threshold level of targeted gas is detected in the air, and to open the valve to permit air flow into the targeted gas capture chamber (120, 520) based on the determination.

### TECHNICAL FIELD

The present invention is directed generally to air purification. More particularly, various inventive methods and apparatus disclosed herein relate to capturing and removing/reducing targeted gases from air.

### BACKGROUND OF THE INVENTION

Carbon dioxide (CO₂) is normally present in air at levels near 400 parts per million (“ppm”). However, CO₂ levels indoors may rise to unhealthy levels. For example, during sleeping hours in bedrooms, carbon dioxide levels may rise above 1,000 ppm. Various types of air purification systems may be configured to remove and/or reduce various types of pollutants (e.g., particles, volatile organic compounds) or other elements in the air. However, unless these air purification systems are vented to areas outside of an environment being purified (e.g., to the outdoors), they may not be well-suited for reducing CO₂ levels. Thus, there is a need in the art to remove and/or reduce targeted gases such as CO₂ from an indoor environment in a cost-effective manner, without requiring ventilation to an outside environment.

### SUMMARY OF THE INVENTION

The present disclosure is directed to inventive methods and apparatus for air purification. The invention is defined by the independent claims. The dependent claims define advantageous embodiments.

For example, an air purification system may be equipped with a targeted gas reduction apparatus that is configured to capture and/or concentrate a targeted gas such as CO₂ from the air, so that the captured/concentrated targeted gas can be periodically removed. In some embodiments, the targeted gas reduction apparatus may include a targeted gas capture chamber for capturing and/or concentrating a targeted gas, and a targeted gas removal unit that may be used to periodically “refresh” the targeted gas capture chamber, so that the targeted gas capture chamber can continue to capture and/or concentrate the targeted gas.

Generally, in one embodiment, an apparatus may include: a targeted gas capture chamber comprising an air inlet and an air-permeable wall configured to capture a targeted gas from air that passes into the air inlet and through the air-permeable wall; a valve that is operable to permit air to flow into the air inlet; a controller operably coupled with the valve and configured to make a determination, based on a signal indicative of a level of the targeted gas detected in the air, that that a threshold level of targeted gas is detected in the air, and to open the valve to permit air flow into the air inlet based on the determination; and a targeted gas removal unit that is positionable adjacent the targeted gas capture chamber while the valve is closed to remove the targeted gas captured by the air-permeable wall e.g. via adsorption.

In various embodiments, the air-permeable wall is further configured to concentrate the targeted gas. In various embodiments, the apparatus may include a sensor operably coupled with the controller and configured to provide the signal indicative of the level of the targeted gas detected in the air. In various embodiments, the targeted gas is carbon dioxide. In various embodiments, the threshold level is greater than 400 ppm, such as between 500 and 700 ppm. In various versions, the controller is configured to open the valve to divert a fraction of an entire air stream that passes through the air purification system into the air inlet, wherein carbon dioxide is removed from the diverted portion of the air flow. In various versions, the controller is configured to periodically open and close the valve while the targeted gas sensor detects an amount of carbon dioxide in the air that satisfies the threshold level of targeted gas. In various versions, the air-permeable wall comprises zeolite materials.

In various embodiments, the targeted gas removal unit comprises an agent configured to chemically bind with carbon dioxide, wherein the agent is CaO or Li(OH)2. In various embodiments, the apparatus includes a pump configured to depressurize the targeted gas capture chamber while the targeted gas removal unit is positioned adjacent the targeted gas capture chamber to draw the targeted gas from the air-permeable wall to the targeted gas removal unit. In various embodiments, the air-permeable wall defines the targeted gas capture chamber to be cylindrical. In various embodiments, the targeted gas removal unit has a cylindrical shape and fits into the targeted gas capture chamber. In other embodiments, the targeted gas removal unit has a cylindrical shape that defines an inner passage, and is configured to encompass the air-permeable wall.

In another aspect, a method for reducing a targeted gas in air may include the following operations: monitoring an air stream for a targeted gas; diverting at least a portion of the air stream through an air inlet of a targeted gas capture chamber in response to a determination, based on the monitoring, that the targeted gas has reached a threshold level, the targeted gas capture chamber including an air-permeable wall configured to capture the targeted gas from air that passes through the air inlet and through the air-permeable wall; and periodically positioning a targeted gas removal unit adjacent the targeted gas capture chamber to remove the targeted gas captured by the air-permeable wall.

These and other aspects of the invention will be apparent from and elucidated with reference to the embodiments described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIGS. 1 and 2 schematically depict an example air purification system configured with selected aspects of the present disclosure, in first and second configurations, respectively, in accordance with various embodiments.

FIGS. 3 and 4 schematically depict an example targeted gas reduction apparatus configured with selected aspects of the present disclosure, in first and second configurations, respectively, in accordance with various embodiments.

FIGS. 5 and 6 schematically depict another example targeted gas reduction apparatus configured with selected aspects of the present disclosure, in first and second configurations, respectively, in accordance with various embodiments.

FIG. 7 depicts a flowchart of an example method for reducing and/or removing a targeted gas from the air, in accordance with various embodiments.

### DETAILED DESCRIPTION OF EMBODIMENTS

Throughout the description reference is made to the wording “positionable”. This refers to “capable of being positioned”.

In an aspect of the invention, an air purification apparatus is presented. The air purification apparatus comprises a targeted gas capture chamber 120, 520 comprising an air inlet 118 and an air-permeable wall 122, 522 configured to at least partially capture a targeted gas from air that passes through the air-permeable wall 122, 522. At least a part of the air which enters the air purification apparatus may enter the target gas capture chamber 120, 520 via the air inlet 118. The air that enters the target gas chamber 120, 520 may leave the target gas chamber by flowing through the air-permeable wall 122,522 which performs a targeted gas filtering or capturing function. The air purification apparatus further comprises a targeted gas removal unit 126, 526 that is positionable adjacent to the air-permeable wall 122, 522 to at least partially remove the targeted gas captured by the air-permeable wall 122, 522. The targeted gas removal unit 126, 526 is moveable within the air purification apparatus and can during operation be positioned adjacent to, e.g. parallel to, the air permeable wall 122, 522. Preferably the targeted gas removal unit 126, 526 may be positioned directly adjacent to the air permeable wall 122, 522, with no other components or parts in between. By placing the targeted gas removal unit 126, 526 close to the air permeable wall 122, 522 an optimal cleaning or maintenance of the air-permeable wall 122, 522 can be performed. The air purification apparatus further comprises a pump 128, 528 configured to change pressure in the targeted gas capture chamber 120, 520, when the targeted gas removal unit 126, 526 is positioned adjacent to the air-permeable wall 122, 522, to draw the targeted gas captured by the air-permeable wall 122, 522 to the targeted gas removal unit 126, 526. During operation of the air purification apparatus, the pump may be activated to change the pressure of the targeted gas capture chamber 120, 520. Under influence of the pressure, the targeted gas that is captured by the air permeable wall 122, 522 is drawn away from the air permeable wall 122, 522. The targeted gas removal unit 126, 526 is positioned such that, depending on the applied pressure, the targeted gas drawn away from the air permeable wall 122, 522 is captured and held by the targeted gas removal unit 126, 526.

According to an embodiment of the invention, the air purification apparatus may comprise a mechanical structure for positioning the targeted gas removal unit 126, 526 close to, e.g. adjacent to, the air permeable wall 122, 522. The mechanical structure may contain a motor for moving the targeted gas removal unit 126, 526. The mechanical structure may be driven by a controller. The controller may receive input from the user. For example, the air purification apparatus may contain a sensor for sensing the amount of targeted gas capture by the air permeable wall 122, 522. When a certain pre-defined threshold is reached, the user may be notified. In such a situation the user is required to take action to start the cleaning process. Alternatively, the sensor may be coupled to the controller. This allows an automatic cleaning or maintenance procedure of the air permeable wall 122, 522 when the threshold is reached.

It is an advantage of the invention that the captured gas by the targeted gas capture chamber 120, 520 can be transferred to the targeted gas removal unit 126, 526 in an automated way. It is an important advantage of the invention, that the air purification apparatus performs purification of air without the need for leading the captured targeted gas away from the air purification apparatus, e.g. outside of a room. The targeted gas captured by the air-permeable wall 122, 522 and thereafter transferred to the targeted gas removal unit 126, 526 can easily be removed by the user. Hence, the air purification apparatus can be used in confined spaces which do not have access to other spaces, e.g. when no air outlets to outside are present. Further, it is an advantage of the invention that by using a pressure difference for drawing captured gas from the targeted gas chamber to the targeted gas removal unit, a more efficient cleaning of the target gas chamber can be achieved.

In another aspect of the invention, an air purification apparatus 110, 510 is presented. The targeted gas capture chamber 120, 520 comprises an air inlet 118 and an air-permeable wall 122, 522 configured to at least partially capture a targeted gas from air that passes through the air-permeable wall 122, 522. At least a part of the air which enters the air purification apparatus may enter the target gas capture chamber 120, 520 via the air inlet 118. The air that enters the target gas chamber 120, 520 may leave the target gas chamber 120, 520 only by flowing through the air-permeable wall 122, 522 which performs a targeted gas filtering or capturing function. The air purification apparatus 110, 510 further comprises a targeted gas sensor 112 positioned for performing a targeted gas measurement on the air flowing into the air purification apparatus and consequently on the air flowing into the target gas capture chamber 120, 520. The air purification apparatus 110, 510 further comprises a valve 116, 516 that is operable to permit air to flow from the air inlet 118 into the targeted gas capture chamber 120, 520. The air purification apparatus 110, 510 further comprises a controller 114 operably coupled with the targeted gas sensor 112 and the valve 116, 516 and configured to make a determination, based on a signal indicative of a level of the targeted gas sensed by the targeted gas sensor 112 in the air, that a pre-defined threshold level of targeted gas is detected in the air, and to open the valve 116, 516 to permit air flow into the targeted gas capture chamber 120, 520 based on the determination.

This aspect of the invention solves the problem of providing a low power, low maintenance, long life-time and efficient device for removing a targeted gas such as carbon dioxide from air, e.g. in the bedroom space. The low power advantage is achieved by only directing air into the target gas chamber 120, 520 when the targeted gas sensor measures a certain target gas value, e.g. a value above a certain pre-defined threshold. The low maintenance advantage is achieved by only directing a part of the air into the target gas chamber. It was noticed by the inventors that for a targeted gas such as carbon dioxide, acceptable purification can be achieved by only directing a part of the air into the targeted gas chamber 120, 520. As the targeted gas chamber 120, 520 is exposed to lower amounts of the targeted gas, the air permeable wall 122 needs to be cleaned less often. Also, the life-time of the targeted gas chamber 120, 520 increases. In this aspect of the invention, the presence of targeted gas removal unit 126, 526 and pump 128, 528 is not required.

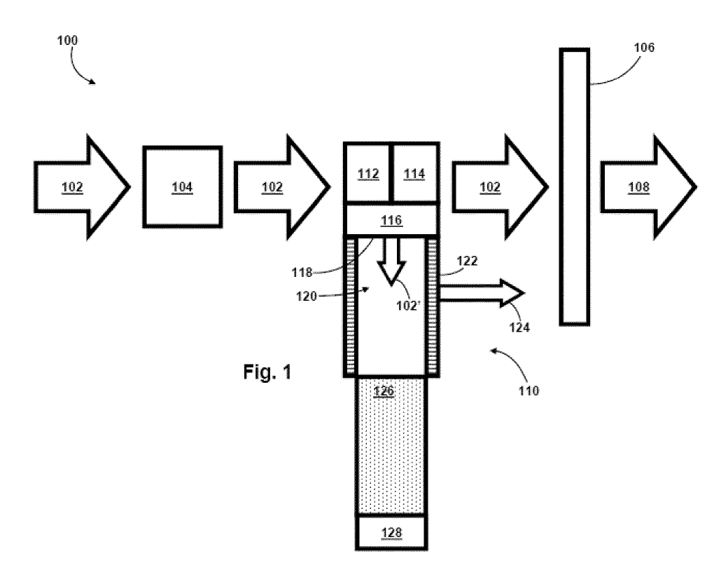

In FIG. 1, an example air purification system 100 is schematically depicted and may be configured to capture, reduce and/or remove pollutants and other undesirable elements from untreated air 102. Air purification system 100 may circulate air 102 in the direction shown by the arrows using a fan 104 or other similar device. Air purification system 100 may also include one or more filters 106 configured to capture various types of pollutants (e.g., particulates, chemicals, volatile organic compounds, etc.). In some embodiments, filter 106 may capture pollutant particles mechanically, e.g., by having pores or channels sized to permit passage of air but not targeted particles. In some embodiments, filter 106 may include (e.g., be immersed in or sprayed with) one or more chemicals configured to react with pollutants in the air (e.g., volatile organic compounds), e.g., to bind and capture the pollutants. Air 108 that has passed through filter 106 may thereafter be considered “treated” or “clean.”

As noted in the background, there may be situations in which it is desirable to target one or more gases (e.g., CO₂) for capture, reduction, and/or removal from air 102 without requiring that air purification system 100 vent air to an outside environment. Accordingly, in some embodiments, air purification system 100 may be equipped with a targeted gas reduction apparatus 110. Targeted gas reduction apparatus 110 may be configured to receive at least a portion of untreated air 102 that passes through air purification system 100, and to capture one or more targeted gases contained in that untreated air 102. For example, in embodiments described herein, targeted gas reduction apparatus 110 is configured to capture, reduce, and/or remove CO₂ from untreated air 102. However, this is not required, and other gases may be targeted for capture and/or removal using similar techniques.

In various embodiments, air purification system 100 may be configured to operate targeted gas reduction apparatus 110 under a variety of circumstances. For example, in some embodiments, air purification system 100 may be equipped with a targeted gas sensor 112 configured to detect presence of, and/or measure levels of, one or more gases that is targeted for capture, reduction, and/or removal from untreated air 102. In FIG. 1, for example, targeted gas sensor 112 may be configured to detect CO₂ levels in untreated air 102. Targeted gas sensor 112 may be operably coupled with a controller 114, so that controller 114 receives, from targeted gas sensor 112, a signal indicative of CO₂ levels detected in untreated air 102. If controller 114 determines based on the signal that detected levels of CO₂ exceed some threshold (e.g., user-selected, programmed at the factory, etc.), controller 114 may take various responsive actions to operate targeted gas reduction apparatus 110 to reduce CO₂ levels. In some embodiments, targeted gas sensor 112 may be placed at locations other than those depicted in FIG. 1. For example, in some embodiments, targeted gas sensor 112 may be placed at any position within an environment that is being treated by air purification system 100. In some such embodiments, targeted gas sensor 112 may be in communication with controller 114 using various wired or wireless technologies, such as Wi-Fi, Bluetooth, radio, and so forth.

In some embodiments, upon determining, based on a signal from targeted gas sensor 112, that CO₂ levels have risen above a threshold, controller 114 may operate a valve 116 or another similar mechanism that is operable to divert at least a portion 102′ of an entire air stream (e.g., untreated air 102) through an air intake 118 of a targeted gas capture chamber 120. Targeted gas capture chamber 120 may include at least one air-permeable wall 122 that is configured to capture one or more targeted gases while permitting “targeted-gas-less” air 124 to pass through and beyond to either downstream components (e.g., filter 106) or into the environment.

In various embodiments, air-permeable wall 122 may include various chemicals or other components selected to capture CO₂ using various processes, such as adsorption. For example, in some embodiments, air-permeable wall 122 may include zeolite materials (e.g., lower silica Li-zeolites [LiLSX]) for concentrating CO₂ within air-permeable wall 122. In some embodiments, air-permeable wall 122 may include zeolite beads of various sizes and in varying numbers in order to capture and/or concentrate CO₂ in air-permeable wall 122. For example, in some embodiments, 300-900 g of zeolite beads may be employed, and in some instances, approximately 600 g of zeolite beads may be employed. In some embodiments, zeolite beads may be between 0.1 and 0.9 mm, such as 0.6 mm, and may be arranged to have an adsorption depth of approximately 20 mm.

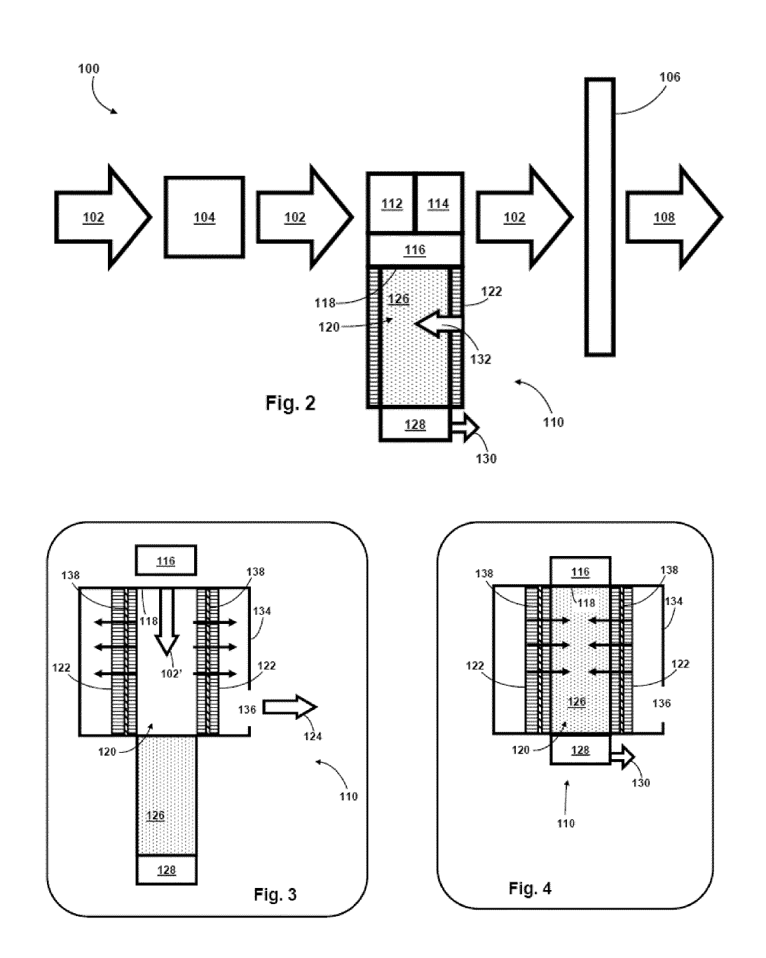

At some point during use, air-permeable wall 122 may become saturated with CO₂, and may no longer be capable of capturing or concentrating CO₂ effectively. Accordingly, in various embodiments, and as is depicted in FIG. 2, a targeted gas removal unit 126 may be selectively (e.g., periodically) positionable into (e.g., inserted into) targeted gas capture chamber 120 in order to “refresh” air-permeable wall 122 by removing the targeted gas captured and/or concentrated in air-permeable wall 122. In this embodiment, the targeted gas removal unit 126 is positioned in a space within the targeted gas capture chamber 120. This space receives the to-be-purified air via the air inlet 118. Preferably, when the targeted gas removal unit 126 is positioned in the targeted gas capture chamber 120, air may only leave the targeted gas capture chamber 120 via the air permeable wall 122. To achieve this, valve 116 acting on the air inlet 118 may be closed. Additionally, other closure means may be present to air-tightly seal the targeted gas capture chamber 120 except the air-permeable wall 122.

Targeted gas removal unit 126 may include (e.g., be treated with, sprayed with, immersed in, etc.) various chemicals (or combinations of chemicals), agents, and so forth that are configured to remove targeted gases such as CO₂. In some embodiments, targeted gas removal unit 126 may include a plurality of zeolite beads in numbers and/or sizes selected, for instance, to expedite adsorption of CO₂ from air-permeable wall 122. In some embodiments, targeted gas removal unit 126 may be treated with various other chemicals or combinations of chemicals, such as calcium oxide (CaO) and/or lithium hydroxide (Li(OH)₂). For example, Li(OH)₂ may be combined with water (H₂O) to yield Li(OH).H₂O(s), which may interact (e.g., adsorb, absorb) with CO₂ to yield Li₂CO₃(s) and H₂O. In some embodiments, sodium peroxide (Na₂O₂) may be employed, and may interact (e.g., adsorb, absorb) with CO₂ to yield Na₂CO₃ and ½ O₂.

In embodiments in which targeted gas removal unit 126 is treated with CaO, the CaO may be combined with water (H₂O) to yield Ca(OH)₂ and heat. The Ca(OH)₂ may then bind with CO₂ captured and/or concentrated in air-permeable wall 122 to yield CaCO₃ and H₂O byproduct (e.g., water vapor). In some embodiments, assuming targeted gas removal unit 126 is not yet saturated with CaCO₃ and/or has not expended all of its CaO, the H₂O byproduct may then be combined with the remaining CaO to yield additional Ca(OH)₂, and the process may be repeated. Once targeted gas removal unit 126 is saturated with CaCO₃ and/or has no CaO remaining, it may be replaced.

Various mechanisms may be employed when targeted gas removal unit 126 is inserted into targeted gas capture chamber 120 in order to draw the targeted gas from air-permeable wall 122 into targeted gas removal unit 126. In some embodiments, including the example depicted in FIGS. 1 and 2, an air pump 128 may be employed or configured to pump a relatively small amount of air 130 from targeted gas capture chamber 120. Thus, air is pumped out of the targeted gas capture chamber 120. This may effectively depressurize targeted gas capture chamber 120 so that it tends to draw a small amount of air 132 in through air-permeable wall 122 and/or through air intake 118 (if valve 116 is open). This small intake of air may draw targeted gas captured by air-permeable wall 122 towards targeted gas removal unit 126, where it may be adsorbed. Air pump 128 may come in various configurations and/or have various capabilities. For example, in some embodiments, an air pump 128 having a capacity between 0.01 and 0.5 m³/h, such as 0.25 m³/h, may be employed. In some such embodiments, air pump 128 may use a relatively small amount of power, such as 20 W. In some embodiments, air pump 128 may create a vacuum having a pressure between 100 and 900 Pa, such as approximately 500 Pa.

FIGS. 3 and 4 schematically depict targeted gas reduction apparatus 110 in more detail. While targeted gas reduction apparatus 110 may be used as part of an air purification system 100 as described above, in other embodiments, targeted gas reduction apparatus 110 could be deployed in an indoor environment on its own. In FIG. 3, targeted gas reduction apparatus 110 is in a targeted gas capture and/or concentration state (e.g., as depicted in FIG. 1), in which targeted gas removal unit 126 is removed from targeted gas capture chamber 120. Valve 116 is open, permitting air 102′ to pass through air intake 118 into targeted gas capture chamber 120. As indicated by the black arrows, air is able to pass through air-permeable wall 122 into an outer chamber 134, and eventually is expelled through passage 136. Meanwhile, air-permeable wall 122 captures and/or concentrates a targeted gas such as CO₂, so that air passing through air-permeable wall 122 is free of, or at least has a reduced amount of, the targeted gas.

Targeted gas reduction apparatus 110 may be maintained, e.g., by controller 114, in the state depicted in FIG. 3 for various time intervals, depending on a variety of factors, such as a level of targeted gas detected (e.g., by targeted gas sensor 112) in the air, time of day, user preferences, and so forth. In some implementations, targeted gas reduction apparatus 110 may be maintained in the state depicted in FIG. 3 for several minutes.

In FIGS. 3 and 4, the target gas removal unit 126, 526 is positionable around the targeted gas capture chamber 120, 520. Thus, when positioned, the target gas removal unit 126, 526 may at least partially surround the targeted gas capture chamber 120, 520. The target gas removal unit 126, 526 may be sized to fit inside the outer chamber 134. As an advantage, the outer chamber 134 may be used as a chamber to create a pressure in the targeted gas capture chamber 120, 520. Air may still flow from the air permeable wall into the outer chamber 134. Preferably, when positioned, the target gas removal unit 126, 526 is located directly adjacent to the air-permeable wall 122 with no other components or parts located in between. This allows a good capture of the targeted gas released by the air-permeable wall 122 under the applied pressure. Preferably, when the targeted gas removal unit 126, 526 is positioned outside of the targeted gas capture chamber 120, air may only leave the targeted gas capture chamber 120 via the air permeable wall 122. To achieve this, valve 116 acting on the air inlet 118 may be closed. Additionally, other closure means may be present to air-tightly seal the targeted gas capture chamber 120 except the air-permeable wall 122.

FIG. 4 depicts targeted gas reduction apparatus 110 in a targeted gas removal state (e.g., as depicted in FIG. 2), in which targeted gas removal unit 126 is inserted into targeted gas capture chamber 120. Valve 116 is closed, occluding air intake 118. Air pump 128 is activated, pumping air 130 out of targeted gas capture chamber 120, which in turn draws air into targeted gas capture chamber 120 through air-permeable wall 122 as indicated by the black arrows. As described above, this air flow and consequent depressurization causes the targeted gas that is captured in air-permeable wall 122 to be drawn into targeted gas removal unit 126. One or more chemical agents in targeted gas removal unit 126 may then interact with (e.g., absorb) the targeted gas, essentially “refreshing” air-permeable wall 122 so that it may capture and/or concentrate more targeted gas when targeted gas reduction apparatus 110 is transitioned back into the targeted gas capture and/or concentration state depicted in FIGS. 1 and 3.

Targeted gas reduction apparatus 110 may be maintained, e.g., by controller 114, in the state depicted in FIG. 4 for various time intervals, depending on a variety of factors, such as a level of targeted gas detected (e.g., by targeted gas sensor 112) in the air, time of day, user preferences, number of times targeted gas removal unit 126 has been inserted since it was last replaced, time passed since targeted gas removal unit 126 was last replaced, and so forth. In some implementations, targeted gas reduction apparatus 110 may be maintained in the state depicted in FIG. 4 for several minutes.

Also visible in FIGS. 3 and 4 are water vapor channels 138. In some implementations, heat generated by a reaction between a chemical agent in air-permeable wall 122 (e.g., zeolite) and the targeted gas may generate, e.g., as a byproduct, water vapor. Additionally or alternatively, heat generated by a reaction of a chemical agent in targeted gas removal unit 126 with targeted gas drawn from air-permeable wall 122 (e.g., as depicted in FIG. 4) may facilitate compression of water vapor into water vapor channels 138. In some implementations, that water vapor byproduct may be captured and/or diverted from air-permeable wall 122 by water vapor channels 138, e.g., to be combined later with targeted gas remaining in targeted gas removal unit 126.

In various implementations, targeted gas removal unit 126 may take the form of a cartridge that can be selectively inserted into and removed from targeted gas capture chamber 120 as described above. As the cartridge is used repeatedly, it may eventually become saturated with targeted gas, e.g., in a matter of days, weeks, or even months. Accordingly, in some implementations, targeted gas removal unit 126 may be periodically replaced, and may be in a form that a “used” (e.g., saturated) targeted gas removal unit 126 may be readily disposed of in the trash, or may be recycled (e.g., by being sent to a facility where it can be relieved of the targeted gas using various chemical processes). Deploying targeted gas removal unit 126 as a disposable cartridge may permit targeted gas reduction apparatus 110 to be employed in an indoor environment without requiring any sort of air outlet to and area outside of the indoor environment. Instead, targeted gas is removed during replacement of targeted gas removal unit 126.

In various embodiments, various components of targeted gas reduction apparatus 110 may have various shapes, dimensions, and other characteristics selected to improve performance. For example, in some embodiments, air-permeable wall 122 may define a cylindrical targeted gas capture chamber 120. In some embodiments, such a cylindrical targeted gas capture chamber 120 may have an inner diameter of between 30 and 100 mm, such as approximately 65 mm. In some embodiments, such a cylindrical targeted gas capture chamber 120 may have an outer diameter of between 50 and 150 mm, such as approximately 105 mm. Thus, for instance, in one embodiment, air-permeable wall 122 may be approximately 20 mm thick. In some embodiments, a length (or height) of targeted gas capture chamber 120 may be between 200 and 300 mm, such as approximately 260 mm.

Targeted gas removal unit 126 may likewise have a cylindrical shape, and may be sized to fit relatively snugly within targeted gas capture chamber 120, e.g., so that targeted gas removal unit 126 is concentric with targeted gas capture chamber 120. While in the targeted gas capture and concentration state depicted in FIGS. 1 and 3, targeted gas removal unit 126 may in some embodiments be spatially separated from targeted gas capture chamber 120 and air-permeable wall 122, e.g., to prevent heat from being transferred from air-permeable wall 122 (where the heat facilitates collection and/or compression of water vapor) to targeted gas removal unit 126.

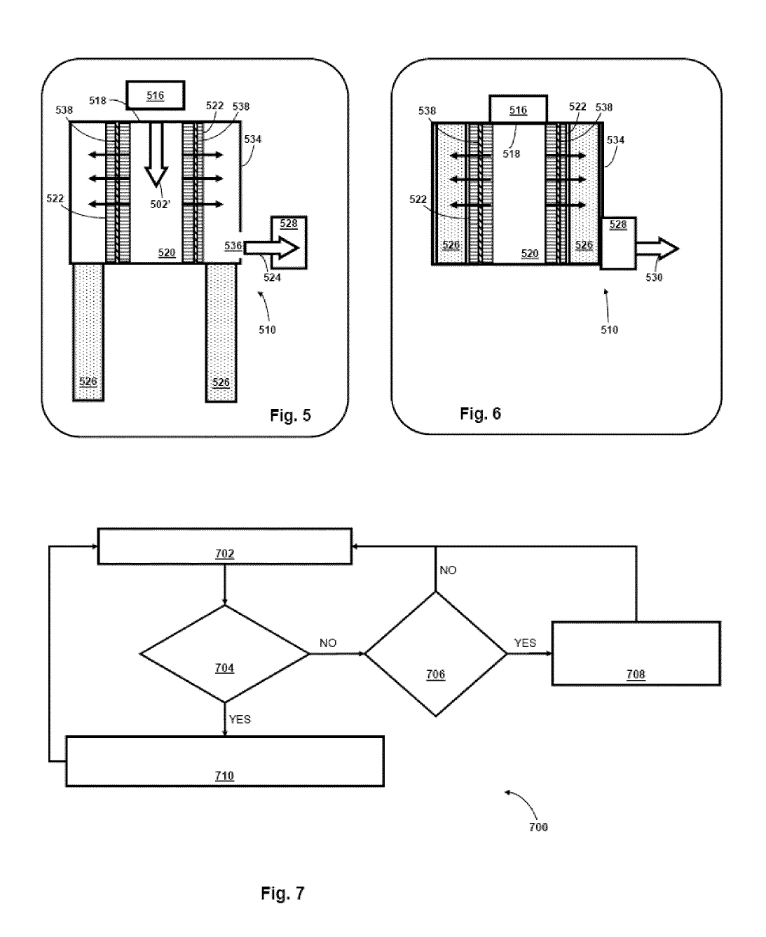

FIGS. 5 and 6 depict an alternative embodiment of a targeted gas reduction apparatus 510, in accordance with various embodiments. Targeted gas reduction apparatus 510 includes many components that are similar to those depicted in FIGS. 1-4, and therefore, those components are numbered similarly (except beginning with a “5” rather than a “1”). Unless otherwise indicated, those components perform the same functions in FIGS. 5 and 6 as they did in FIGS. 1-4. In the embodiment of FIGS. 5 and 6, targeted gas removal unit 526 is designed to be selectively moved to a position inside of outer chamber 534 but outside of air-permeable wall 122 and targeted gas capture chamber 120, as opposed to into targeted gas capture chamber 120 as was the case in FIGS. 1-4.

In FIG. 5, targeted gas reduction apparatus 510 is in a targeted gas capture and/or concentration state (similar to the configurations depicted in FIGS. 1 and 3), in which targeted gas removal unit 526 is removed from outer chamber 534 so that it does not encompass targeted gas capture chamber 520 and air-permeable wall 522. In this example, targeted gas removal unit 526 is cylindrical and defines an inner passage 257. Valve 516 is open, permitting air 502′ to pass through air intake 518 into targeted gas capture chamber 520. In some embodiments, a mechanism (not depicted) may be used to block or occlude a lower portion of targeted gas capture chamber 520. As indicated by the black arrows, air is able to pass through air-permeable wall 522 into outer chamber 534. This air may then pass through passage 536 and be expelled as targeted-gas-free-air 524.

FIG. 6 depicts targeted gas reduction apparatus 510 in a targeted gas removal state (similar to the configurations depicted in FIGS. 2 and 4), in which targeted gas removal unit 526 is inserted into outer chamber 534 so that it encompasses, e.g., in passage 527, air-permeable wall 522 and targeted gas capture chamber 520. Valve 516 is closed, occluding air intake 518. Air pump 528 is positioned adjacent passage 536 so that when activated, air pump 528 may pump air 530 out of outer chamber 534, which in turn draws air out of (and depressurizes) targeted gas capture chamber 520 as indicated by the black arrows. As described above, this air flow causes the targeted gas that is captured in air-permeable wall 522 to be drawn into targeted gas removal unit 526. One or more chemical agents in targeted gas removal unit 526 may then interact with (e.g., absorb) the targeted gas, essentially “refreshing” air-permeable wall 522 as described above.

In another aspect of the invention, a method for reducing a targeted gas in air is presented. The method comprises a step of providing an air purification device 110, 510. The air purification device 110, 510 comprises a targeted gas capture chamber 120, 520 comprising an air inlet 118, 518 and an air-permeable wall 122, 522 configured to at least partially capture a targeted gas from air that passes through the air-permeable wall 122, 522. The method further comprises a step of monitoring 702 or sensing an air stream for a targeted gas. The method further comprises a step of diverting 710 a fraction of the air stream through the air inlet 118, 518 of the targeted gas capture chamber 122, 522 in response to a determination, based on the monitoring, that the targeted gas has reached a pre-defined threshold level.

FIG. 7 depicts a flowchart of one example method of reducing and/or capturing a targeted gas, in accordance with various embodiments. At block 702, an air stream (e.g., air 102 passing through air purification system 100) may be monitored for a targeted gas such as CO₂. At block 704, if the air stream does not contain an amount of the targeted gas that exceeds some threshold (e.g., 600 ppm CO₂), then method 700 proceeds to block 706. At block 706, if air is not currently being diverted through an air inlet (e.g., 118) into a targeted gas capture chamber (e.g., valve 116 is closed), then method 700 may proceed back to block 702.

However, if at block 706, air is currently being diverted into a targeted gas capture chamber (e.g., valve 116 is open), then method 700 may proceed to block 708. At block 708, air flow through the air inlet (e.g., 118) may be ceased, e.g., by closing valve 116, and method 700 may proceed back to block 702. Back at block 704, if air monitored at block 702 exceeds some predetermined threshold (e.g., 600 ppm CO₂), then method 700 may proceed to block 710. At block 710, a portion of a total air flow, e.g., being directed through air purification system 100, may be diverted through the air inlet into the targeted gas capture chamber, where targeted gas present in the air may be captured and/or concentrated, e.g., in air-permeable wall 122.

In some embodiments, the targeted gas threshold employed at block 704 may be selected deliberately to be higher than an amount of the targeted gas typically found in safe air. For example, CO₂ may normally be present in air at approximately 400 ppm, but the threshold employed in an air purification system configured with selected aspects of the present disclosure may be set to between 500 and 700 ppm, such as at 600 ppm. By setting this threshold relatively high, targeted gas reduction apparatus 110 and/or 510 may be sized smaller than if the threshold were set to a lower level, say, 400 ppm and still provide “acceptable” air quality. In addition, in some embodiments, only a portion or fraction of total air flow is diverted at block 710, further enabling targeted gas reduction apparatus 110 or 510 to be relatively small.

In some embodiments, rather than closing valve 116 immediately after determining that the targeted gas threshold is no longer met, valve 116 may simply be opened for a selected time interval, and then closed. For example, in some embodiments, valve 116 may be opened for one minute, five minutes, six minutes, and so on. In some embodiments, a remaining “lifetime” of targeted gas removal unit 126 (e.g., how long until it can no longer effectively remove CO₂ from air-permeable wall 122) may be calculated based on an aggregated sum of targeted gas measured at block 702 over a period of time.

In another aspect of the invention, a method for maintaining an air purification apparatus 110, 510 is presented. The method comprises a step of providing an air purification device 110, 510 comprising: a targeted gas capture chamber 120, 520 comprising an air-permeable wall 122, 522 configured to at least partially capture a targeted gas from air that passes through the air-permeable wall 122, 522, and a targeted gas removal unit 126, 526 for at least partially removing the targeted gas captured by the air-permeable wall 122, 522. The method further comprises the step of positioning the targeted gas removal unit 126, 526 adjacent to the air-permeable wall 122, 522 of the targeted gas capture chamber 120, 520 to at least partially remove the targeted gas captured by the air-permeable wall 122, 522. The method further comprises the step of changing pressure within or inside the targeted gas capture chamber 120, 520 thereby drawing the targeted gas captured by the air-permeable wall 122, 522 to the targeted gas removal unit 126, 526.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The controller may be implemented by means of hardware comprising several distinct elements, and/or by means of a suitably programmed processor. In the device claim enumerating several means, several of these means may be embodied by one and the same item of hardware. The mere fact that certain measures are recited in mutually different dependent claims does not indicate that a combination of these measures cannot be used to advantage.

1. An air purification apparatus comprising:
a targeted gas capture chamber comprising an air inlet and an air-permeable wall configured to at least partially capture a targeted gas from air that passes through the air-permeable wall;
a targeted gas removal unit that is positionable adjacent to the air-permeable wall to at least partially remove the targeted gas captured by the air-permeable wall;
a pump configured to depressurize the targeted gas capture chamber when the targeted gas removal unit is positioned adjacent to the air-permeable wall to draw the targeted gas captured by the air-permeable wall to the targeted gas removal unit; and
wherein the targeted gas removal unit comprises an agent configured to chemically bind with the targeted gas.

2. The air purification apparatus according to claim 1, wherein the targeted gas removal unit is positionable inside the targeted gas capture chamber, and wherein the pump is configured to pump air out of the targeted gas capture chamber.

3. The air purification apparatus according to claim 1, wherein the targeted gas removal unit is positionable outside of the targeted gas capture chamber.

4. The air purification apparatus according to claim 3, further comprising an outer chamber surrounding the targeted gas capture chamber, wherein the targeted gas removal unit is sized to fit into the outer chamber such that the targeted gas removal unit is positionable into the outer chamber thereby surrounding the targeted gas capture chamber, and wherein the pump is configured to pump air out of the outer chamber.

5. (canceled)

6. The air purification apparatus according to claim 1, wherein the targeted gas removal unit is a disposable or recyclable cartridge.

7. The air purification apparatus according to claim 1, further comprising a valve that is operable to permit air to flow from the air inlet into the targeted gas capture chamber, and wherein the valve is configured to occlude air intake from the air inlet into the targeted gas capture chamber when the targeted gas removal unit is positioned adjacent to the air-permeable wall.

8. (canceled)

9. (canceled)

10. (canceled)

11. (canceled)

12. (canceled)

13. A method for maintaining an air purification apparatus, the method comprising:
providing an air purification device comprising:
a targeted gas capture chamber comprising an air-permeable wall configured to at least partially capture a targeted gas from air that passes through the air-permeable wall;
a targeted gas removal unit for at least partially removing the targeted gas captured by the air-permeable wall, wherein the targeted gas removal unit comprises an agent configured to chemically bind with the targeted gas;
positioning the targeted gas removal unit adjacent to the air-permeable wall of the targeted gas capture chamber to at least partially remove the targeted gas captured by the air-permeable wall; and
depressurizing the targeted gas capture chamber thereby drawing the targeted gas captured by the air-permeable wall to the targeted gas removal unit.

14. (canceled)

15. The method according to claim 13, wherein the targeted gas is carbon dioxide.

16. The air purification apparatus according to claim 1, wherein the targeted gas is carbon dioxide.
